(19) United States
(12) Patent Application Publication
(10) Pub. No.: US 2004/0150529 A1
(43) Pub. Date: Aug. 5, 2004

(54) Power harvesting sensor for monitoring and control

(76) Inventors: Jeffrey T. Benoit, Willington, CT (US); Balkrishna S. Annigeri, Glastonbury, CT (US); Richard P. Card JR., Woodbury, CT (US); Fanping Sun, Glastonbury, CT (US); Bhalchandra R. Tulpule, Farmington, CT (US); Howard A. Winston, Woodbury, CT (US)

Correspondence Address: CARLSON, GASKEY & OLDS, P.C., 400 WEST MAPLE ROAD, SUITE 350, BIRMINGHAM, MI, 48009, US

(21) Appl. No.: 10/354,579

(22) Filed: Jan. 30, 2003

(51) Int. Cl. G08B 21/00

(52) U.S. Cl. 340/679; 340/693.1; 340/870.16; 340/539.3

(57) ABSTRACT

A sensor system includes a power harvesting subsystem, a control subsystem, a sensor subsystem and a communication subsystem. Electromechanical systems generate and dissipate multiple forms of waste energy as a by-product of system operation. Waste energy in the system may lead to destructive side effects which adversely affect the life of system elements. The sensor system is powered above a predetermined level and communicates the sensed information to a remote processor for system diagnosis.

### BACKGROUND OF THE INVENTION

The present invention relates to a sensor system, and more particularly to powering a remote sensor with damage initiating waste energy harvested from the system which the sensor is monitoring.

Many systems require the sensing of system parameters for monitoring system health and control of system functions. Sensors are commonly remotely located upon the system which requires monitoring. The sensors communicate with a central processor through wireless links. Many such systems are often located in remote regions which complicates powering the remotely located sensors. The remote sensor systems, however, must still be reliably powered.

Typically, conventional remote sensor systems are battery powered. Although effective in certain benign environments, temperature and mechanical limitations preclude their use in many applications. Moreover, the limited total energy of battery power necessitates replacement at frequent intervals which may be costly and time consuming for many essentially inaccessible locations.

Accordingly, it is desirable to provide a maintenance-free power source for wireless operation of sensor systems.

### SUMMARY OF THE INVENTION

The remote sensor system according to the present invention harvests energy from the system and its environment to provide power for the sensor system itself. Electromechanical systems generate and dissipate multiple forms of energy as a by-product of system operation. Waste heat, mechanical and acoustical vibrations are examples of this type of energy. In some instances waste energy leads to destructive side effects which adversely effect the life of the system components. A portion of this waste energy is harvested and converted to electrical energy to power the sensing system. Examples of sensing functions include those required to monitor the health of system components or those required to control the operation of the system itself.

Waste energy such as mechanical vibration above a predetermined level for greater than a predetermined time may eventually damage or destroy system elements. For example only, vibration generated by a helicopter transmission is a normal waste energy. Although requiring routine maintenance, normal vibration levels are not a threat to operation of the helicopter transmission. Should internally or externally generated difficulties increase the vibration above a predetermined level, however, life-limiting damage to the helicopter transmission may occur. The sensor system according to the present invention becomes powered by waste vibrational energy and communicates the sensed information to a remote processor for system diagnosis.

The present invention therefore provides a maintenance-free power source for wireless operation of sensor systems.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general schematic view of a system having a sensor system designed according to the present invention;

FIG. 2 is a general perspective view of an exemplary rotary wing aircraft embodiment for use with the present invention; and

FIG. 3 is a general schematic view of the sensor system.

### DETAILED DESCRIPTION OF THE PREFERRED EMBODIMENT

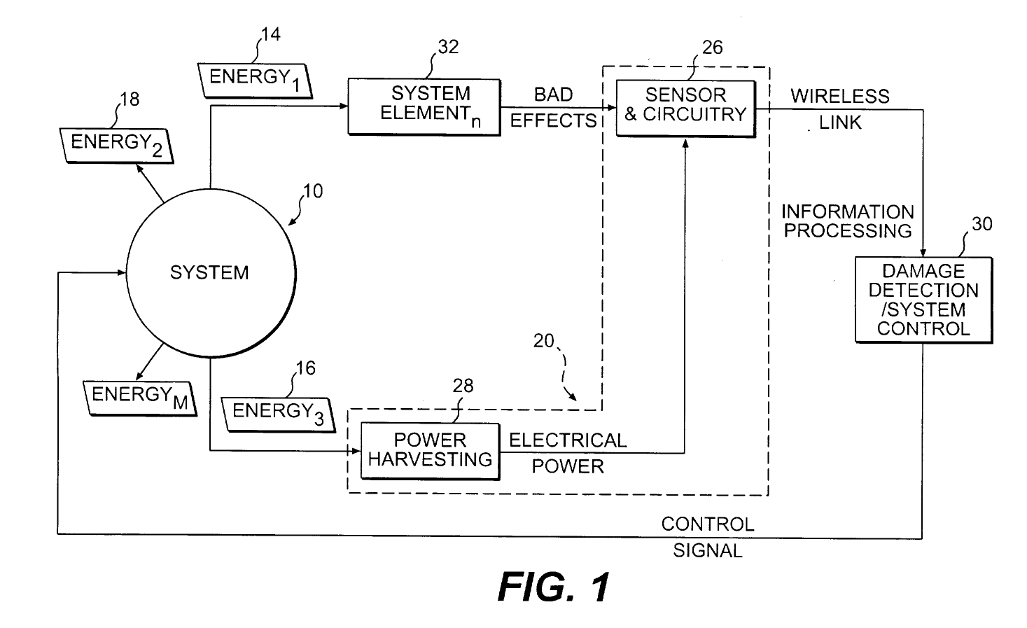

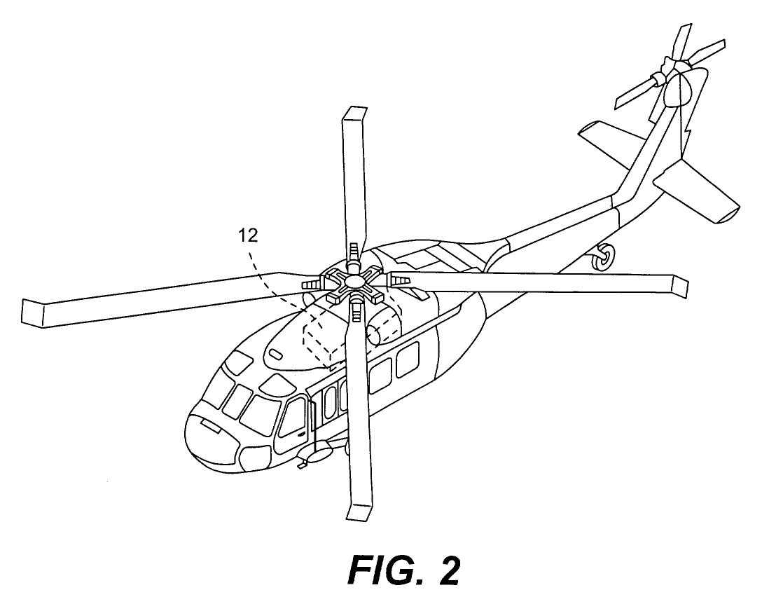

FIG. 1 illustrates a general perspective view of a system 10. System 10 may be any type of mechanical or electromechanical system which generates and dissipates multiple forms of energy as a by-product of the system's operation such as a helicopter transmission (illustrated schematically at 12 in FIG. 2). It should be understood that although a helicopter transmission is disclosed in the illustrative embodiment, the present invention should not be limited to only such a system.

System 10 generates multiple sources of energy, Energy₁, Energy₂, . . . Energyₘ. Waste energy such as heat (illustrated schematically at 14), mechanical vibration (illustrated schematically at 16) and acoustical vibrations (illustrated schematically at 18) are examples of this type of energy, however, other forms of energy may also be generated and benefit from the present invention.

Waste energy in the system may lead to destructive effects which adversely effect the life of system elements such as mechanical vibration above a predetermined level for greater than a predetermined time which may eventually damage or destroy the system 10 or elements thereof or attached thereto. In other words, waste energy of a predetermined level is a normal output of a properly functioning system 10 and although reducing a useful life of the system and system elements, over long periods of operation, the predetermined level of waste energy is not a short term threat to system operation.

For example only, mechanical vibration generated by the helicopter transmission 12 (FIG. 2) is a normal waste energy due to system operation. Although requiring routine maintenance, normal levels of mechanical vibration is not a short term threat to operation of the helicopter transmission 12. “Short term” may be defined herein as a time shorter than the time between which routine maintenance is performed. Should internally or externally generated difficulties increase the mechanical vibration above a predetermined level, however, life-limiting damage to the helicopter transmission 12 may occur.

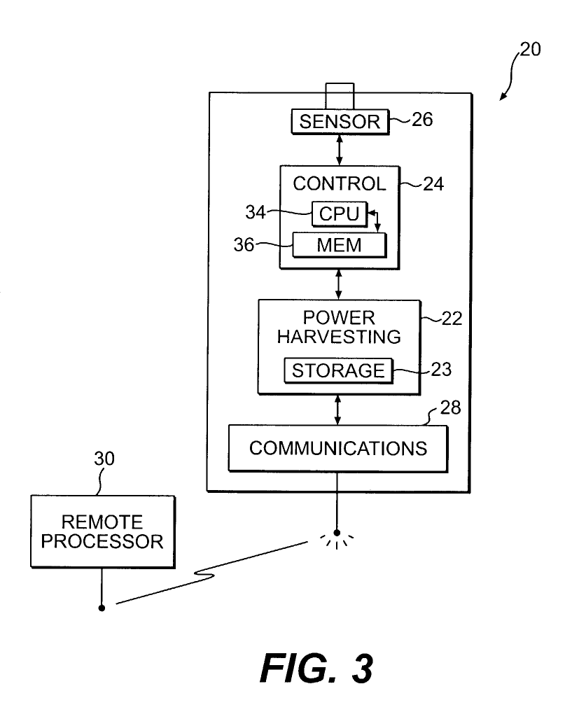

A sensor system 20 is preferably powered by the waste energy. Sensor system 20 (also schematically illustrated in FIG. 3) preferably includes a power harvesting subsystem 22, a control subsystem 24, a sensor subsystem 26 and a communication subsystem 28. It should be understood that various sensor systems will benefit from the present invention.

The sensor system 20 remotely communicates with a processor 30 or the like. As the sensor system 20 harvests and utilizes the waste energy from the system 10 and its environment, which the sensor system 20 is monitoring and/or controlling to power the sensor system 20 itself, the sensor system 20 is completely remote and self-contained.

The power harvesting subsystem 22 harvests energy from the waste energy, such as mechanical vibration 16, that is generated by the system 10. Preferably, the harvesting subsystem 22 includes a piezoelectric transducer which converts mechanical vibration into electrical energy to power the sensor system 20. It should be understood that other mechanical, chemical, electromagnetic, thermal and nuclear power harvesting devices will also benefit from the present invention. A storage cell 23 such as a battery or capacitor may alternatively or additionally be provided to store electrical energy to extend sensor system 20 operation or to provide additional energy, when needed, for communication to the remote processor 30. The power harvesting subsystem 22 may alternatively or additionally be performing its task of harvesting and storing energy until the stored energy within the storage cell 23 is sufficient to then power the control subsystem 24, sensor subsystem 26 and the communication subsystem 28 for a short time to take a measurement and send this information to the processor 30. That is, the energy harvester may be ‘awake’ when the rest of the circuit remains dormant.

The power harvesting subsystem 22 operates above a predetermined level of waste energy. The predetermined level of waste energy is preferably a level of waste energy above normal levels of waste energy such as vibrations which, if left uncorrected for prolonged time periods, may cause system damage. It should be understood that normal predetermined levels may also be sufficient to continuously power the sensor system whenever the system is operating. It should be further understood that due to the complex nature of the spectral (over frequency) energy distribution of a dynamic strain field (vibration), the sensor system may alternatively or additionally be calibrated to be operational at normal levels of waste energy and not just at hazardous levels of waste energy. Monitoring conditions experienced by the overall system allows for the extension of the usual scheduled maintenance intervals or even eliminating them such that the system need only have maintenance based on the sensed knowledge of its condition to provide condition based maintenance.

Once the predetermined level is reached, the power harvesting subsystem 22 is powered and operational. The sensor subsystem 26 operates to sense a system element 32 which may include the waste energy which powers the sensor system 20 such as vibration or another separate waste energy such as heat. System element 32 may alternatively or additionally be another system or related system value which provides advantageous system information. It should be understood that the system element includes structures which may fail after prolonged exposure to system waste energy.

The sensor subsystem 26 communicates the sensed value to the processor 30 through the communication subsystem 28. The communication subsystem 28 preferably provides a wireless link such as RF, IR or other wireless links between the processor 30 and communication subsystem 28. Other arrangements which do not require communication will also benefit from the present invention, such as information storage, color change, or the like.

The processor 30 detects, analyzes and/or stores the information from the sensor system to alert an operator or store information for later retrieval. The processor 30 may be a stand alone processor which provides independent damage detection and system control functions or may be integrated with other system processors such as a central flight control system processor or the like.

The control subsystem 24 of the sensor system 20 alternatively or additionally provides analysis and/or storage separate from the processor 30. The control subsystem 24 includes a CPU 34 and storage device 36 connected to the CPU 34. The storage device 36 may include RAM or other optically readable storage, magnetic storage or integrated circuit. CPU 34 preferably contains an instruction set for operation of the sensor system 20 and communication with the processor 30. The control subsystem 30 alternatively or additionally provides for closed-loop functions which allow further system control and operation of the monitored system 10.

Although described with respect to a transmission, the invention, may be practiced in other structures or in other applications with sufficient waste energy to power the sensor system. For example only, other systems such as missiles, helicopter blades, wings, blades of air moving machinery, blades of wind energy electric power generators, or support struts within a fluid flow, etc will also benefit from the present invention.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A power harvesting remote sensor system comprising:
a sensor subsystem; and
a power harvesting subsystem which draws power from a system waste energy, said power harvesting subsystem powering said sensor subsystems and said communication subsystem above a predetermined level of system waste energy.

2. The remote sensor system as recited in claim 1, further comprising a piezoelectric transducer to draw power from said system waste energy.

3. The remote sensor system as recited in claim 1, wherein said system waste energy comprises a mechanical vibration.

4. The remote sensor system as recited in claim 1, wherein said system waste energy comprises an acoustic vibration.

5. The remote sensor system as recited in claim 1, wherein said sensor subsystem senses heat energy.

6. The remote sensor system as recited in claim 1, wherein said predetermined level of system waste energy comprises a level above normal levels of waste energy.

7. The remote sensor system as recited in claim 1, wherein said predetermined level of system waste energy comprises a damage initiating waste energy level.

8. The remote sensor system as recited in claim 1, further comprising a communication subsystem comprises a wireless link to communicate information between said sensor subsystem and a remote processor.

9. The remote sensor system as recited in claim 1, wherein said system comprises a helicopter system.

10. A method of operating a remote sensor system comprising the steps of:
(1) harvesting a waste energy from a system above a predetermined level of system waste energy;
(2) converting the waste energy into electrical energy to power a sensor subsystem and a communication subsystem; and
(3) communicating information through the communication subsystem between the sensor subsystem and a remote processor.

11. A method as recited in claim 10, wherein said step (1) further comprises harvesting the waste energy in response to the predetermined level of system waste energy being greater than a damage initiating waste energy level.

12. A method as recited in claim 10, wherein said step (1) further comprises harvesting the waste energy in response to the predetermined level of system waste energy being greater than a normal waste energy level generated by the system.

13. A method as recited in claim 10, wherein said step (1) further comprises harvesting a mechanical vibration waste energy in response to the mechanical vibration waste energy being greater than normal mechanical vibration waste energy generated by the system

14. A method as recited in claim 10, wherein said step (1) further comprises harvesting a mechanical vibration waste energy in response to the mechanical vibration waste energy being greater than damage initiation mechanical vibration waste energy generated by the system.

15. A method as recited in claim 10, wherein said step (3) further comprises communicating information through a wireless link.

16. A method of operating a remote sensor system comprising the steps of:
(1) harvesting a mechanical vibration waste energy from a system above a predetermined level of mechanical vibration waste energy;
(2) converting the mechanical vibration waste energy into electrical energy to power a sensor subsystem and a communication subsystem;
(3) sensing a system element; and
(4) communicating information sensed in said step (3) to a remote processor.

17. A method as recited in claim 16, wherein said step (1) further comprises harvesting the mechanical vibration waste energy in response to the predetermined level of mechanical vibration waste energy being greater than a damage initiating mechanical vibration waste energy level.

18. A method as recited in claim 16, wherein said step (1) further comprises harvesting the mechanical vibration waste energy in response to said predetermined level of mechanical vibration waste energy being greater than a normal mechanical vibration waste energy generated by the system.

19. A method as recited in claim 16, further comprising the step of storing the electrical energy from said step (2) prior to said step (4).
